(19) United States
(12) Patent Application Publication
(10) Pub. No.: US 2026/0280143 A1
(43) Pub. Date: Sep. 17, 2026

(54) ANTENNA ASSEMBLY

(71) Applicant: KYOCERA AVX Components (San Diego), Inc., San Diego, CA (US)

(72) Inventors: Weichun Eric Lin, San Diego, CA (US); Rey Anthony Aspiras Eguilos, Perris, CA (US)

(21) Appl. No.: 19/170,877

(22) Filed: Apr. 4, 2025

Related U.S. Application Data
(60) Provisional application No. 63/575,246, filed on Apr. 5, 2024.

(51) Int. Cl. H01Q 21/06; H01Q 5/20; H01Q 21/28

(52) U.S. Cl. CPC H01Q 21/061; H01Q 5/20; H01Q 21/28

(57) ABSTRACT

An antenna assembly is provided. The antenna assembly includes a carrier having a first surface defining a reference plane, a plurality of apertures extending through the carrier, the plurality of apertures positioned along a first side of the carrier, the first side of the carrier adjacent to a second side and a third side of the carrier. The antenna assembly further includes a plurality of antennas positioned on the first surface. The antenna assembly further includes a plurality of electrical cables extending along the first surface of the carrier, each electrical cable of the plurality of electrical cables coupled to an antenna of the plurality of antennas and extending through an aperture of the plurality of apertures. A first electrical cable of the plurality of electrical cables is in contact with a conductive structure positioned along the first side of the carrier.

### PRIORITY CLAIM

The present application is based on and claims priority to U.S. Provisional Application 63/575,246 having a filing date of Apr. 5, 2024, which is incorporated by reference herein.

### FIELD

The present disclosure relates generally to an antenna assembly, and more specifically to an antenna assembly having multiple antennas.

### BACKGROUND

Antennas can be used to facilitate wireless communication between devices. It can be desirable for antennas to operate with a high efficiency to improve wireless communication between devices. Antennas may be incorporated into a variety of different types of electronic devices to provide for wireless communication. An antenna assembly may include one or more antennas to facilitate wireless communication over a variety of different frequency bands/protocols.

### SUMMARY

Aspects and advantages of embodiments of the present disclosure will be set forth in part in the following description, or can be learned from the description, or can be learned through practice of the embodiments.

One example aspect of the present disclosure is directed to an antenna assembly. The antenna assembly includes a carrier having a first surface defining a reference plane, a plurality of apertures extending through the carrier, the plurality of apertures positioned along a first side of the carrier, the first side of the carrier adjacent to a second side and a third side of the carrier. The antenna assembly further includes a plurality of antennas positioned on the first surface. The antenna assembly further includes a plurality of electrical cables extending along the first surface of the carrier, each electrical cable of the plurality of electrical cables coupled to an antenna of the plurality of antennas and extending through an aperture of the plurality of apertures. A first electrical cable of the plurality of electrical cables is in contact with a conductive structure positioned along the first side of the carrier.

Another example aspect of the present disclosure is directed to an antenna assembly. The antenna assembly includes a carrier having a first surface defining a reference plane, a plurality of apertures extending through the carrier, the plurality of apertures positioned along a first side of the carrier, the first side of the carrier adjacent to a second side and a third side of the carrier. The antenna assembly further includes a plurality of electrical cables extending along the first surface of the carrier. The antenna assembly further includes a plurality of antennas positioned on the first surface. The plurality of antennas include a first antenna coupled to a first electrical cable of the plurality of electrical cables, the first electrical cable extending through a first aperture of the plurality of apertures. The plurality of antennas further include a second antenna coupled to a second electrical cable of the plurality of electrical cables, the second electrical cable extending through a second aperture of the plurality of apertures. The plurality of antennas further include a third antenna coupled to a third electrical cable of the plurality of electrical cables, the third electrical cable extending through a third aperture of the plurality of apertures. The first electrical cable is in contact with a conductive structure positioned along the first side of the carrier.

Another example aspect of the present disclosure is directed to an electronic device. The electronic device includes an antenna cabinet comprising a metal sidewall. The electronic device further includes an antenna assembly at least partially enclosed within the antenna cabinet. The antenna assembly includes a carrier having a first surface defining a reference plane, a plurality of apertures extending through the carrier. The antenna assembly further includes a plurality of antennas positioned on the first surface. The antenna assembly further includes a plurality of electrical cables extending along the first surface of the carrier, each electrical cable of the plurality of electrical cables coupled to an antenna of the plurality of antennas and extending through an aperture of the plurality of apertures. A first electrical cable of the plurality of electrical cables is in contact with the metal sidewall of the antenna cabinet.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 provides a top-down view of an example antenna assembly according to example embodiments of the present disclosure;

FIG. 2A-2C provide top-down views of example aperture configurations of an example carrier according to example embodiments of the present disclosure

FIG. 3A-3E provide exploded perspective views of various example apertures of an example carrier according to example embodiments;

FIG. 4 provides a block diagram depicting an example electronic device according to example embodiments of the present disclosure;

FIG. 5A-5D depict an example antenna cabinet according to example aspects of the present disclosure;

FIG. 6 provides a bottom-up perspective view of the example carrier 200 according to example embodiments of the present disclosure;

FIGS. 7A and 7B provide efficiency plots of an example first antenna according to example embodiments of the present disclosure;

FIGS. 8A and 8B depict graphical representations of a peak gain of an example first antenna according to example embodiments of the present disclosure;

FIG. 9 provides an efficiency plot of an example second antenna and example third antenna according to example embodiments of the present disclosure;

FIG. 10 depicts a graphical representation of peak gains of an example second antenna and example third antenna according to example embodiments of the present disclosure; and

FIG. 11 provides an example antenna isolation plot of example antennas according to example embodiments of the present disclosure.

Repeat use of reference characters in the present specification and drawings is intended to represent same or analogous features or elements of the invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations. As used herein, the use of the term “about” in conjunction with a numerical value refers to a value that falls within 10% of the stated numerical value.

Example aspects of the present disclosure are directed to an antenna assembly for use in, for instance, a wide variety of applications. For example, the antenna assembly may be implemented in an electronic device to facilitate wireless communication with other devices (e.g., remote devices). The antenna assembly includes multiple antennas to facilitate communication over a variety of different frequency bands/protocols. For instance, the antenna assembly may be operable over frequency bands associated with cellular bands (e.g., long term evolution (LTE)), Bluetooth (BT), WiFi, and Thread systems and/or protocols. The implementation of an antenna assembly within an electronic device and/or antenna cabinet may prove challenging as the physical dimensions of the device may call for a compact antenna assembly. This may provide additional challenges for antenna assemblies with multiple antennas as antenna isolation between the antennas may be negatively impacted. For instance, the configuration (e.g., routing, positioning) of the antennas and other components of the antenna assembly in close proximity may, for example, cause interference between the antennas. This may negatively impact performance characteristics, such as antenna radiation efficiency, of the antennas. As such, an antenna assembly with improved antenna isolation is provided.

Aspects of the present disclosure provide a number of technical effects and benefits. For instance, example embodiments of the present disclosure may provide an antenna assembly with improved antenna isolation and/or antenna radiation efficiency that may be implemented in an electronic device and/or antenna cabinet to facilitate wireless communicate over multiple different frequency bands/protocols such as frequency bands associated with cellular (e.g. (LTE)), Bluetooth (BT), WiFi, and Thread systems and/or protocols. In addition, the example embodiments of the present disclosure may provide an antenna assembly with improved operation over multiple frequency bands while being enclosed within the physical dimensions of, for instance, an electronic device and/or antenna cabinet.

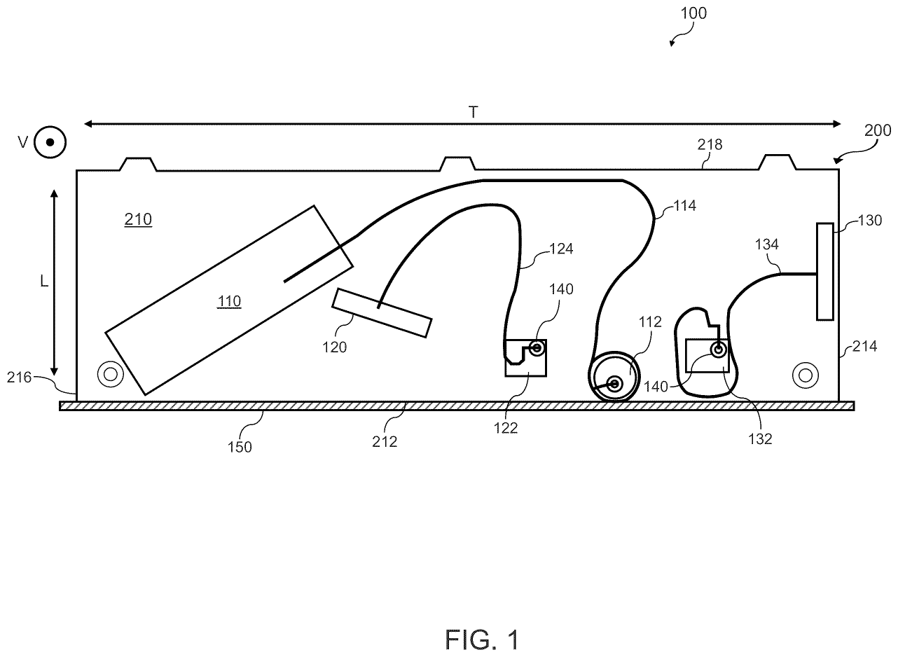

Referring now to FIG. 1, a top-down view of an antenna assembly 100 is provided according to example embodiments of the present disclosure. As shown, antenna assembly 100 may define a vertical direction V, a lateral direction L, and a transverse direction T. The vertical direction V, lateral direction L, and transverse direction T may be mutually perpendicular and form an orthogonal direction system.

As shown, antenna assembly 100 may include a carrier 200 and a plurality of antennas 110, 120, 130 positioned on a first surface 210 of the carrier 200. Carrier 200 may be generally rectangular with a length dimension (e.g., long dimension) extending along the transverse direction T and a width dimension (e.g., short dimension) extending along the lateral direction L. Carrier 200 may have a first surface 210 defining a reference plane. For instance, the first surface 210 may extend along the transverse T and lateral L directions such that it defines a reference plane.

In addition, carrier 200 may have a first side 212, a second side 214, a third side 216, and a fourth side 218. Each side 212, 214, 216, 218 may be adjacent to first surface 210. For instance, first side 212 and a fourth side 218 (e.g., long sides) may have a length along the transverse direction T, while second side 214 and third side 216 (e.g., short sides) may have a length along the lateral direction L that is less than (e.g., shorter than) the length of sides 212, 218 (e.g., long sides) along the transverse direction T. As such, sides 214, 216 (e.g., short sides) of carrier 200 may have a length along the lateral direction L that is less than (e.g., shorter than) the length of sides 212, 218 (e.g., long sides) along the transverse direction T.

Carrier 200 may further include a plurality of apertures 112, 122, 132 extending through carrier 200. As shown, apertures 112, 122, 132 may extend through carrier 200 in a direction perpendicular to the reference plane (e.g., in the vertical V direction). In some embodiments, the apertures 112, 122, 132 may be positioned along first side 212 of carrier 200.

Antenna assembly 100 may further include a plurality of antennas 110, 120, 130 and a plurality of electrical cables 114, 124, 134. Each antenna 110, 120, 130 may be positioned on the first surface 210 of carrier 200. Each electrical cable 114, 124, 134 may be coupled to an antenna 110, 120, 130. As shown, each electrical cable 114, 124, 134 may extend along the first surface 210 of carrier 200 to an aperture 112, 122, 132. In addition, each electrical cable 114, 124, 134 may extend through an aperture 112, 122, 132.

In some embodiments, electrical cables 114, 124, 134 may be transmission lines configured to connect antennas 110, 120, 130 to radio frequency (RF) circuitry. In some embodiments, each electrical cable 114, 124, 134 may be coupled to RF circuitry via an electrical connector 140, such as a FAKRA connector. For instance, each electrical cable 114, 124, 134 may connect an antenna 110, 120, 130 to an electrical connector 140, each electrical connector 140 being coupled to RF circuitry.

As shown in FIG. 1, a conductive structure 150 may be positioned along the first side 212 of carrier 200. Conductive structure 150 may be a generally planar conductive structure. In some embodiments, conductive structure 150 may be generally perpendicular to the reference plane. For instance, conductive structure 150 may be a metal wall (e.g., sidewall) extending along the transverse and vertical directions. First electrical cable 114 connected to the first antenna 110 (e.g., LTE antenna) may be in contact with (e.g., coupled to) conductive structure 150. As shown in FIG. 1, electrical cable 114 may be routed along first surface 210 such that electrical cable 114 contacts conductive structure 150 at coupling point 152. For instance, conductive structure 150 may be configured to reduce or eliminate common mode return current radiated from first antenna 110 through electrical cable 114 to, for instance, radio frequency (RF) circuitry. In some embodiments, electrical cable 114 may be coupled to (e.g., in contact with) conductive structure 150 such that the conductive structure 150 may act as a ground point (e.g., ground plane) to the first antenna 110.

In some embodiments, a first antenna 110 may be an long term evolution (LTE) antenna operable over one or more long term evolution (LTE) frequency bands. In addition, the second antenna 120 and the third antenna 130 may be operable over one or more frequency bands in a range from about 2 GHz to about 5 GHz. For instance, the second antenna 120 may be a thread antenna, while the third antenna 130 may be a Bluetooth (BT) antenna, a Wifi antenna, or a BT/Wifi antenna. Accordingly, the second antenna 120 may be operable to communicate via an 802.15.4 protocol (e.g., communication protocol), while the third antenna may be operable to communicate via an 802.11 protocol.

As shown, the first antenna 110 (e.g., LTE antenna) may be coupled to a first electrical cable 114, the first electrical cable extending along the first surface 210 of carrier 200 and through first aperture 112. Similarly, the second antenna 120 may be coupled to second electrical cable 124, the second electrical cable extending along the first surface 210 of carrier 200 and through second aperture 122, and third antenna 130 may be coupled to third electrical cable 134, the third electrical cable 134 extending along the first surface 210 of carrier 200 and through third aperture 132.

As shown, the plurality of apertures 112, 122, 132 may be positioned along first side 212 of carrier 200. In some embodiments, the plurality of electrical cables 114, 124, 134 may be non-intersecting along the first surface 210 of carrier 200. For instance, each electrical cable 114, 124, 134 may extend along the first surface 210 from each antenna 110, 120, 130 to a corresponding aperture 112, 122, 132 without overlapping (e.g., in the vertical direction V) another electrical cable 114, 124, 134.

Accordingly, the antennas 110, 120, 130 and corresponding apertures 112, 122, 132 may be positioned such that the plurality of electrical cables 114, 124, 134 are non-intersecting (e.g., non-overlapping) along the first surface 210. In some embodiments, the second antenna 120 and the third antenna 130 may be positioned closer to the second side 214 of the carrier 200 relative to first antenna 110 (e.g., LTE antenna). For instance, the second antenna 120 may be positioned between the first antenna 110 and the third antenna 130 in a direction parallel to the first side 212 of the carrier 200 (e.g., transverse direction T). In additional/alternative embodiments, the first aperture 112 (e.g., corresponding to the first antenna 110) may be positioned between the second aperture 122 (e.g., corresponding to the second antenna 120) and the third aperture 132 (e.g., corresponding to the third antenna 130) in a direction parallel to the first side 212 of the carrier 200 (e.g., transverse direction T).

Accordingly, first electrical cable 114 coupled to the first antenna 110 may extend around the second antenna 120 and second electrical cable 124 to the first aperture 112. As shown, the first electrical cable 114 (e.g., a portion of first electrical cable 114) may extend along the fourth side 218 of carrier 200, the fourth side 218 being opposite to the first side 212.

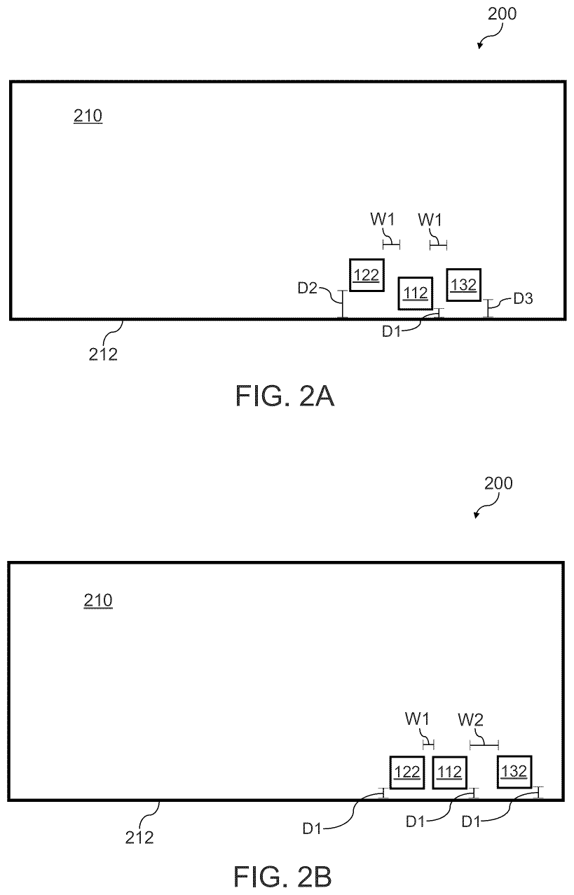

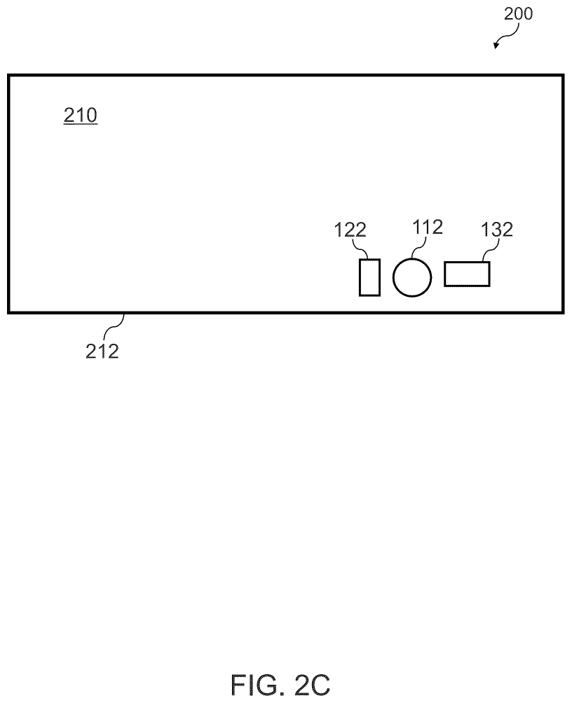

FIG. 2A-2C provide top-down views of example aperture configurations of an example carrier according to example embodiments of the present disclosure. While FIGS. 2A-2C generally refer to the first aperture 112 corresponding to the first antenna 110, second aperture 122 corresponding to the second antenna 120, and third aperture 132 corresponding to the third antenna 130 as depicted in FIG. 1, those of ordinary skill in the art will understand that any of the apertures depicted in FIG. 2A-2C may correspond to any of the antennas described with reference to FIG. 1 without deviating from the scope of the present disclosure. In addition, while carrier 200 is depicted in FIG. 2A-2C as including three apertures, those of ordinary skill in the art will understand that carrier 200 may include any suitable number of apertures without deviating from the scope of the present disclosure.

Referring now specifically to FIG. 2A, carrier 200 is shown having a plurality of apertures 112, 122, 132. As shown, each aperture 112, 122, 132 may be positioned along first side 212 of carrier 200. In some embodiments, apertures 112, 122, 132 may have the same shape. For instance, as shown in FIG. 2A, apertures 112, 122, 132 may be generally square in shape.

Apertures 112, 122, 132 may be spaced apart by a width W1. In some embodiments, the distance (e.g., width W1) between the first aperture 112 and the second aperture 122 may be about the same as the distance (e.g., width W1) between the first aperture 112 and the third aperture 132. In addition, first aperture 112 may be positioned a first distance D1 from the first side 212, and one or more second apertures 122, 132 (e.g., second aperture 122 and third aperture 132) may be positioned one or more second distances (e.g., second distance D2 and third distance D3) from the first side 212.

As shown, the first distance D1 may be different than the one or more second distances (e.g., second distance D2 and third distance D3). For instance, first distance D1 may be less than the one or more second distances (e.g., second distance D2 and third distance D3), such that the first aperture 112 corresponding to first antenna 110 (FIG. 1) may be closer to first side 212 relative to the second aperture 122 and the third aperture 132. In some embodiments, each aperture 112, 122, 132 may be positioned a different distance from first side 212. For instance, third distance D3 of the third aperture 132 may be greater than first distance D1 of the first aperture, and second distance D2 of the second aperture 122 may be greater than the third distance D3 of the third aperture 132.

In some embodiments, each aperture 112, 122, 132 may be positioned the same distance from first side 212. For instance, as shown in FIG. 2B, each aperture 112, 122, 132 may be positioned the same distance D1 from first side 212. In additional/alternative embodiments, the distance between the first aperture 112 and the second aperture 122 may be different than the distance between the first aperture 112 and the third aperture 132. For instance, still referring to FIG. 2B, the distance (e.g., width W1) between the first aperture 112 and the second aperture 122 may be less than the distance (e.g., width W2) between the first aperture 112 and the third aperture 132.

In some embodiments, one or more apertures 112, 122, 132 may have different shapes. For example, as shown in FIG. 2C, the shape of the first aperture 112 may be different than the shape of the one or more second apertures (e.g., second aperture 122, third aperture 132). As shown, the first aperture 112 may have a circular shape, while the second aperture 122 and the third aperture 132 may have a rectangular shape.

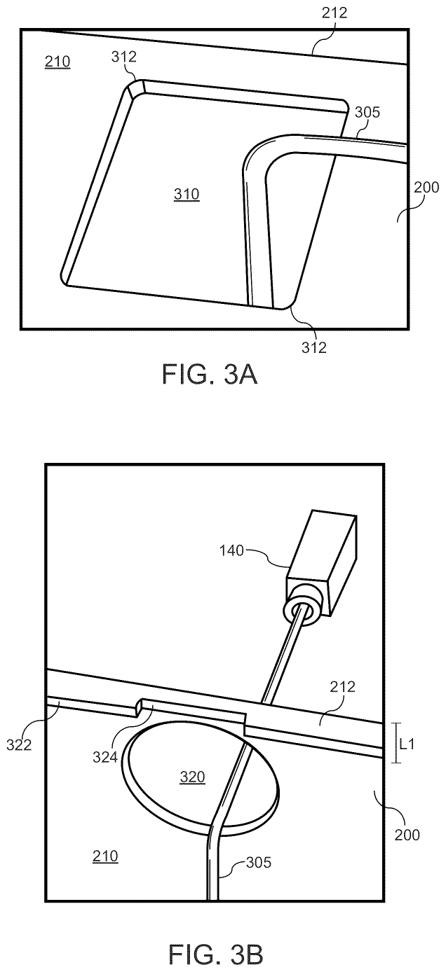

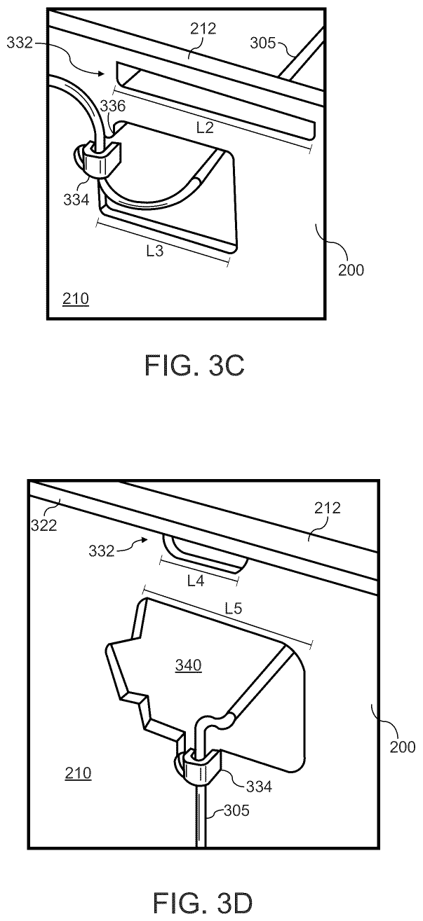

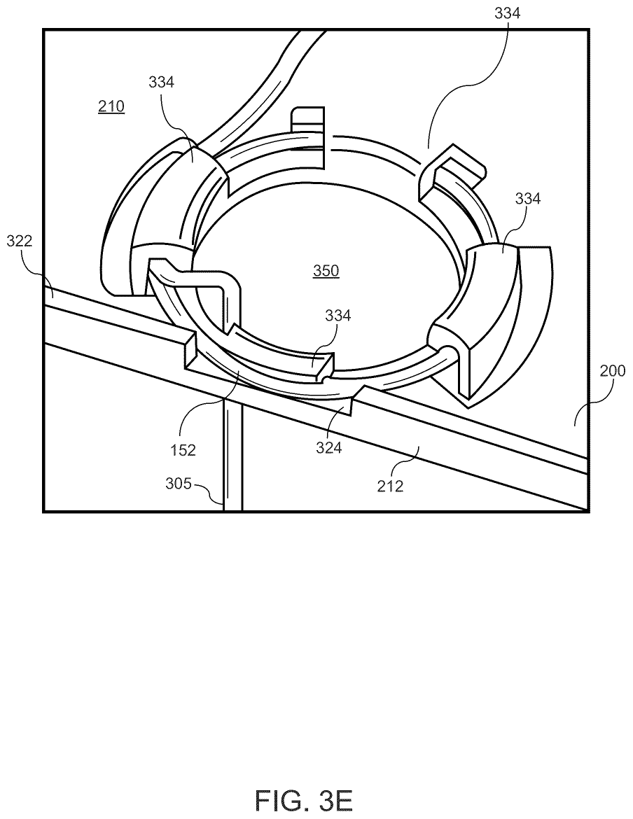

Referring now to FIG. 3A-3E, exploded perspective views of various example apertures of a carrier are provided according to example embodiments of the present disclosure. Those of ordinary skill in the art will understand that aspects or features of any of the apertures depicted in FIG. 2A-2C may correspond to any of the apertures (e.g., first aperture 112, second aperture 122, third aperture 132, etc.) of carrier 200 described with reference to FIG. 1 and/or FIG. 2A-2C.

FIG. 3A depicts an example aperture 310 of an example carrier according to example embodiments of the present disclosure. As previously described, one or more apertures of carrier 200 may be generally square in shape. As shown in FIG. 3A, the shape of aperture 310 is generally square. In some embodiments, one or more corners 312 of aperture 310 may be beveled. FIG. 3A also depicts an example electrical cable 305 according to example embodiments of the present disclosure. As shown, electrical cable 305 may extend along the first surface 210 and through aperture 310.

Referring now to FIG. 3B, another example aperture 320 is depicted according to example embodiments of the present disclosure. As previously described, one or more apertures of carrier 200 may be generally circular in shape. As shown in FIG. 3B, the shape of aperture 320 is circular. FIG. 3B also depicts an electrical cable 305 extending along the first surface 210 and through aperture 310. In some embodiments, electrical cable 305 may be configured to connect an antenna, such as antennas 110, 120, 130 of FIG. 1 to radio frequency (RF) circuitry via an electrical connector 140. For example, as depicted in FIG. 3B, electrical cable 305 may be an antenna transmission line configured to couple an antenna to electrical connector 140, such as a FAKRA connector.

In some embodiments, one or more edge portions of carrier 200, such as edge portion 322 corresponding to first side 212, may protrude from first surface 210 of carrier 200. For instance, as shown in FIG. 3B, edge portion 322 may extend a length L1 beyond the first surface 210. In further embodiments, edge portion 322 may include a notch 324 corresponding to the aperture 320. For instance, the region of edge portion 322 corresponding to the notch 324 may be flush with the first surface 210.

Referring now to FIG. 3C, another example aperture 330 is depicted according to example embodiments of the present disclosure. As shown, aperture 330 may be generally rectangular in shape with one or more corner indentions 336. In some embodiments, carrier 200 may include one or more line clips 334 protruding from first surface 210 to, for instance, support electrical cable 305 along the first surface 210. As shown in FIG. 3C, a line clip 334 may protrude from the first surface 210 at an edge of an aperture, such as aperture 330 shown in FIG. 3C. The line clip 334 may be configured to secure electrical cable 305.

In some embodiments, carrier 200 may further include an edge aperture 332 extending through the carrier 200 at a position corresponding to the aperture 330. As shown, edge aperture 332 may be positioned between the aperture 330 and the first side 212 of carrier 200. In some embodiments, edge aperture 332 may have a length L2 (e.g., parallel to the first side 212) that is greater than length L3 of the corresponding aperture 330.

Referring now to FIG. 3D, another example aperture 340 is depicted according to example embodiments of the present disclosure. In some embodiments, one or more apertures of carrier 200 may be irregularly shaped. As shown in FIG. 3D, aperture 340 is irregularly shaped. A line clip 334 may protrude from the first surface 210 of carrier 200 at an edge (e.g., bottom edge) of aperture 340 to secure electrical cable 305.

In some embodiments, carrier 200 may include one or more edge portions, such as edge portion 322 corresponding to first side surface 210, protruding from first surface 210 of carrier 200 in addition to an edge aperture 322 extending through the carrier 200 at a position corresponding to the aperture, such as aperture 340 shown in FIG. 3C. In additional/alternative embodiments, edge aperture 332 may have a length L4 (e.g., parallel to the first side 212) that is greater than length L5 of the corresponding aperture 340.

FIG. 3E illustrates another example aperture 350 according to example embodiments of the present disclosure. As shown in FIG. 3E, an electrical cable 305 may extend along first surface 210 such that the electrical cable 305 encircles the aperture 350. Accordingly, a plurality of line clips 334 may be positioned around aperture 350 to, for instance, secure the electrical cable 305.

As previously described with reference to FIG. 1, first electrical cable 114 may be routed along first surface 210 such that electrical cable 114 contacts conductive structure 150 at coupling point 152. Accordingly, first electrical cable 114 may correspond to electrical cable 305 depicted in FIG. 3E. For instance, as shown in FIG. 3E, electrical cable 305 may extend into a notch 324 such that electrical cable 305 may contact a conductive structure, such as conductive structure 150 (FIG. 1), positioned along first side 212 of carrier 200 at coupling point 152.

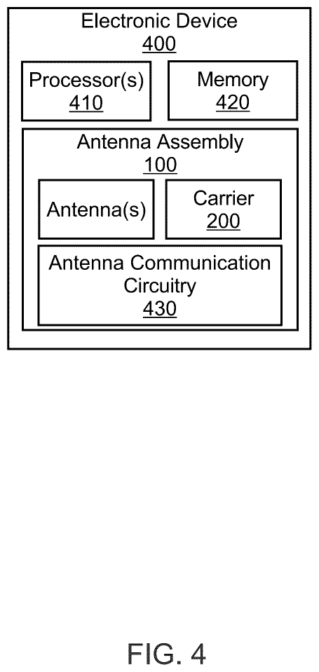

FIG. 4 provides a block diagram depicting an example electronic device according to example embodiments of the present disclosure. Electronic device 400 may be any suitable electronic device configured to have wireless communication with one or more remote devices. For instance, electronic device 400 can be a computing device (e.g., laptop, desktop, display with one or more processors), mobile device (e.g., phone, tablet, wearable device (e.g., watch)), vehicle, nautical vehicle, aircraft, satellite, keyless entry device, or other electronic device. While electronic device 400 is described in FIG. 4 with reference to antenna assembly 100 as shown in FIG. 1, those of ordinary skill in the art, using the disclosures provided herein, will understand that any aspect of antenna assembly 100 described herein can be implemented in electronic device 400 for use in a variety of applications without deviating from the scope of the present disclosure. As shown in FIG. 4, electronic device 400 includes an antenna assembly, such as antenna assembly 100 as provided herein. In some embodiments, electronic device 400 may include an antenna cabinet configured to house (e.g., at least partially house) the antenna assembly 100. As previously described, antenna assembly 100 may include a carrier 200, and a plurality of antennas, such as antennas 110, 120, 130 depicted in FIG. 1, positioned on a first surface of the carrier 200.

Antenna assembly 100 may further include communication circuitry 430. For instance, as shown in FIG. 1, each antenna 110, 120, 130 may be coupled to RF circuitry via electrical cables 114, 124, 134 and electrical connectors 140. Communication circuitry 430 may include electrical components (e.g., radio frequency (RF) circuitry, transmission line, transceiver, receiver, transmitter, matching circuit etc.) configured to facilitate communication of information over the antenna. In some embodiments, processor(s) 410 may be in electrical communication with antenna assembly 100 via communication circuitry 430. In this manner, RF signals received at antenna assembly 100 may be provided to processor(s) 410 via communication circuitry 430. In addition, the one or more processor(s) 410 may be configured to provide data to the antenna assembly 100 via communication circuitry 430 (e.g., electrical connectors 140, electrical cables 114, 124, 134 of communication circuitry 430). RF signals and/or a control signal may be communicated over a transmission line (e.g., coaxial cable) of communication circuitry 430. For instance, as shown in FIG. 1, electrical cables 114, 124, 134 may be antenna transmission lines configured to connect an antenna 110, 120, 130 to a corresponding electrical connector 140, such as a FAKRA connector. Each electrical connector 140 may be coupled to RF circuitry configured to communicate with processor(s) 410 via a network cable, such as an ethernet cable, to facilitate communication of information over the antennas 110, 120, 130.

In some embodiments, electronic device 400 may further include memory 420 and one or more processor(s) 410. Processor(s) 410 can include any suitable processing device and may be configured to perform a variety of computer implemented functions. As used herein, the term “processor” refers not only to integrated circuits referred to in the art as being included in a computer, but may also refer to a microprocessor, CPU, GPU, controller, microcontroller, a microcomputer, a programmable logic controller (PLC), an application specific integrated circuit (ASIC), a Field Programmable Gate Array (FPGA), and/or other programmable circuits. As shown, electronic device 400 may further include memory 420. Examples of memory 420 can include computer-readable media including, but not limited to, non-transitory computer-readable media, such as RAM, ROM, hard drives, flash drives, or other suitable memory devices. Memory 420 can store information accessible by the one or more processor(s) 410, including computer-readable instructions that can be executed by the one or more processor(s) 410. For example, the computer-readable instructions can be software written in any suitable programming language or may be implemented in hardware. In some embodiments, the one or more processor(s) 410 along with memory 420 may be defined as one or more control devices configured to control operation of antenna assembly 100.

In some embodiments, electronic device 400 may further include one or more screen(s) (e.g., display screen, touch screen) and/or one or more input device(s) (e.g., key pad, touch pad, keyboard).

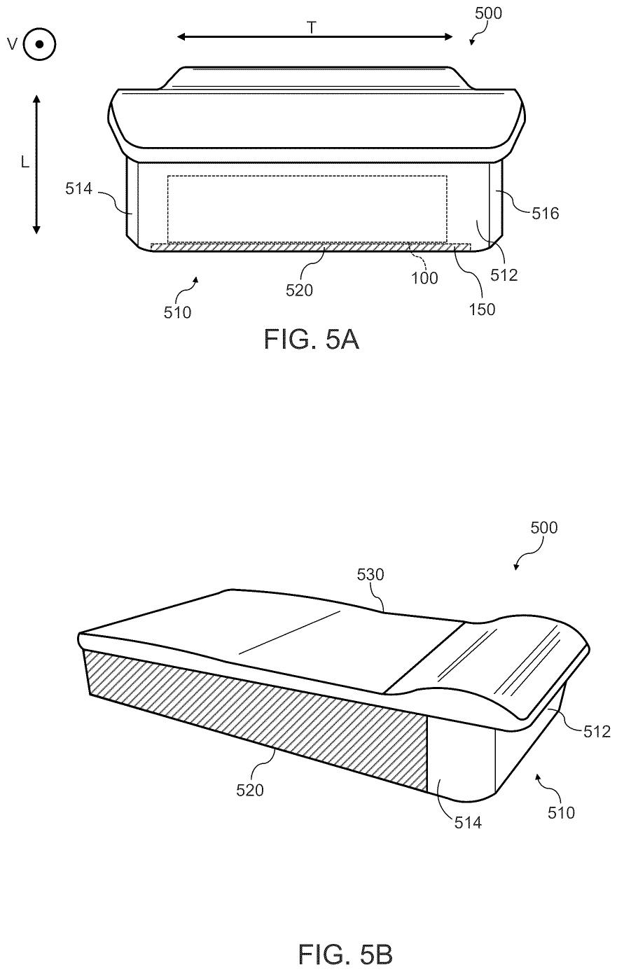

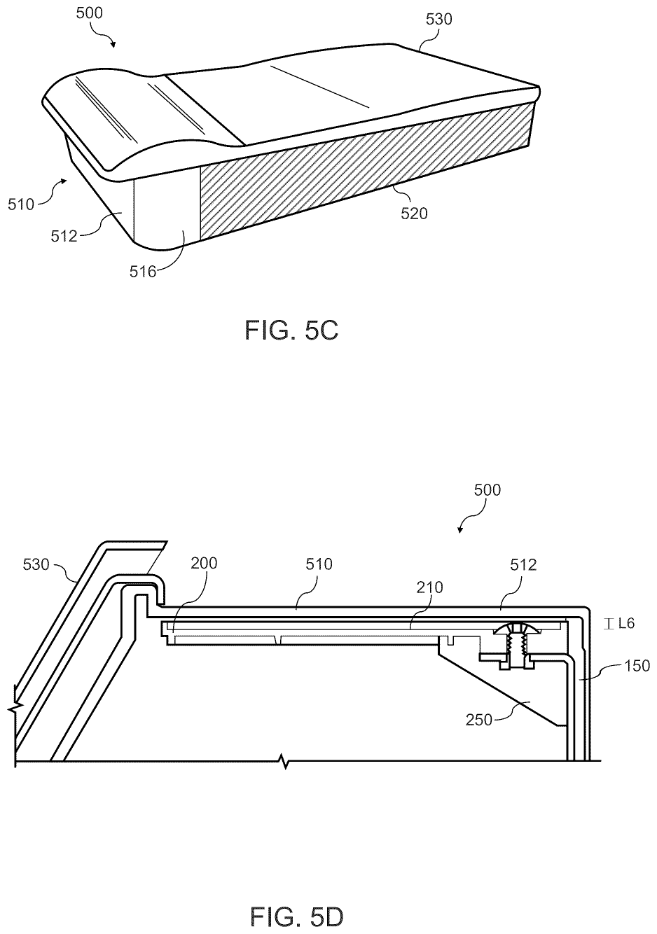

FIG. 5A-5D depict an example antenna cabinet 500 according to example aspects of the present disclosure. Antenna cabinet 500 is configured to house an antenna assembly, such as antenna assembly 100 of FIG. 1. Antenna cabinet 500 may be implemented within an electronic device, such as electronic device 400 of FIG. 4. Specifically, FIG. 5A-5C provide side perspective views of the antenna cabinet 500, and FIG. 5D provides a cross-sectional exploded view of a carrier, such as carrier 200 previously depicted herein within antenna cabinet 500.

Antenna cabinet 500 is configured to house an antenna assembly 100. Antenna cabinet 500 may include an antenna housing portion 510, a metal portion 520, and a lid portion 530. In some embodiments, antenna housing portion 510 may be a plastic housing portion, while metal portion 520 may be made of a conductive (e.g., metal) material. As previously described with reference to FIG. 1, antenna assembly 100 may define a vertical direction V, a lateral direction L, and a transverse direction T.

Antenna assembly 100 may be positioned (e.g., at least partially enclosed) within an antenna housing portion 510 (e.g., plastic housing portion) of antenna cabinet 500. For instance, as illustrated, antenna housing portion 510 may include a first sidewall 512 and curved sidewalls 514, 516. Conductive structure 150 may also be positioned within antenna housing portion 510.

In some embodiments, conductive structure 150 may be a part of the metal portion 520, such as a metal sidewall of the antenna cabinet 500. For example, conductive structure 150 may be a sidewall of metal portion 520 extending in the vertical direction such that the conductive structure 150 is generally perpendicular to the reference plane defined by first surface 210 of carrier 200 (FIG. 1).

Referring now specifically to FIG. 5D, a cross-sectional exploded view of a carrier 200 of antenna assembly 100 within antenna cabinet 500 is provided. As shown, carrier 200 may be positioned within antenna cabinet 500 such that the first surface 210 of the carrier 200 is generally parallel to the first sidewall 512 of the antenna housing portion 510. In some embodiments, antenna assembly 100 may be positioned within antenna cabinet 500 such that the distance (e.g., L6) between the first surface 210 of carrier 200 and the first sidewall 512 is about 3 millimeters (mm). As shown, carrier 200 may include one or more flanges 250 (e.g., plastic flanges) configured to physically couple the carrier 200 to the antenna cabinet 500. In some embodiments, flanges 250 may couple the carrier 200 to the conductive structure 150. For instance, as shown in FIG. 5D, conductive structure 150 (e.g., metal sidewall of antenna cabinet 500) may be generally perpendicular to the first surface 210 of carrier 200.

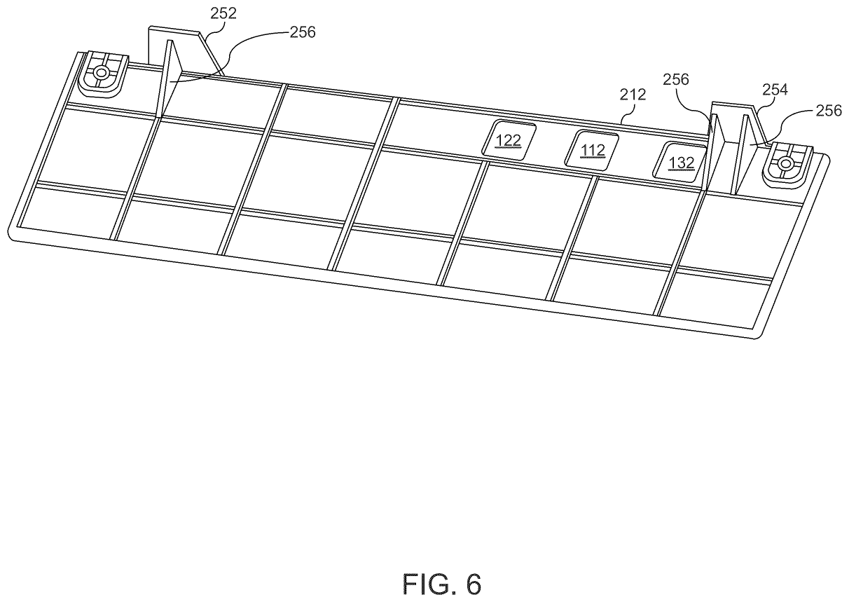

FIG. 6 provides a bottom-up perspective view of the example carrier 200 according to example embodiments of the present disclosure. As shown in FIG. 6, carrier 200 may include a first flange 252 and a second flange 254 positioned along the first side 212 of carrier 200. Each flange 252, 254 may be configured to couple the carrier 200 to, for instance, an antenna cabinet such as antenna cabinet 500 of FIG. 5A-5D. As shown, first flange 252 may include a single supportive member 256, while the second flange 254 may include two supportive members 256.

The plurality of apertures 112, 122, 132 may be positioned between the first flange 252 and the second flange 254 along the first side of the carrier. In some embodiments, each aperture 112, 122, 132 may be positioned closer to the second flange 254 than the first flange 252.

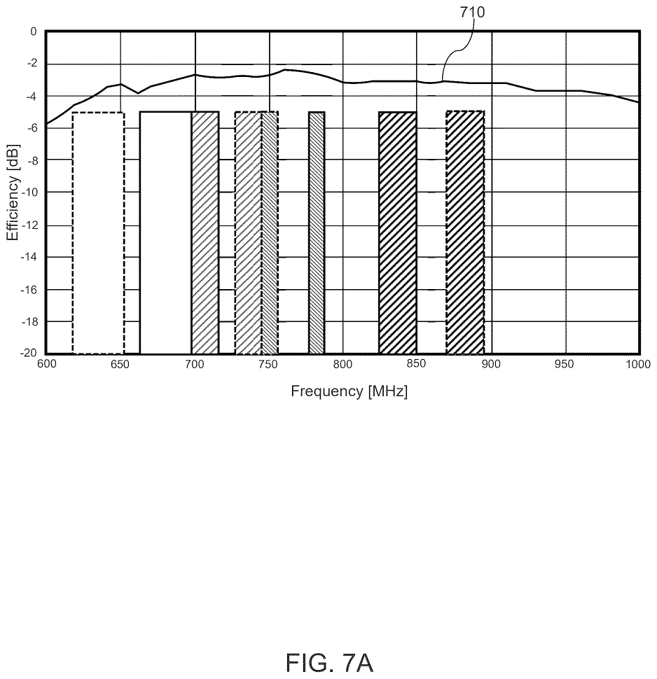

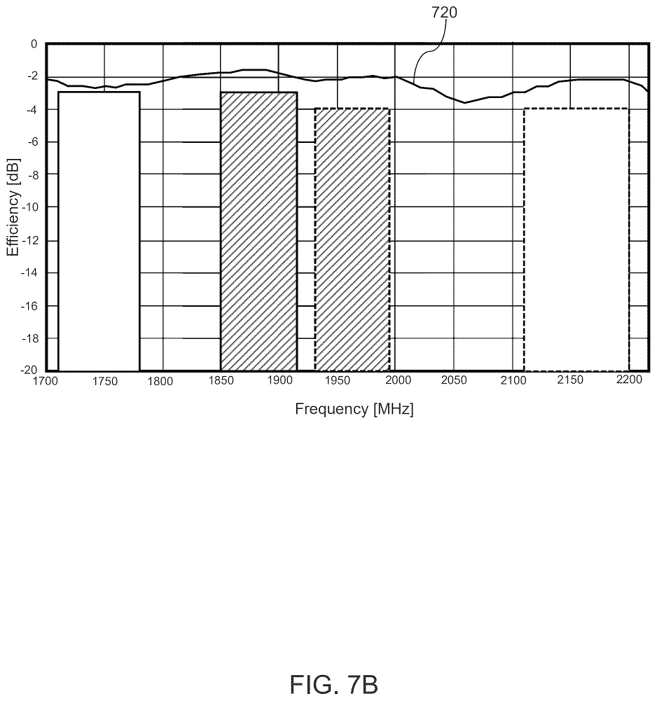

FIGS. 7A and 7B provide plots of example efficiency (e.g., antenna radiation efficiency) of a first antenna 110 of the antenna assembly 100 while at least partially enclosed within antenna cabinet 500 according to example embodiments of the present disclosure. As shown, the plots in FIGS. 7A & 7B illustrate the efficiency (e.g., in decibels [dB]) of the first antenna 110 as a function of frequency (denoted along the horizontal axis in Megahertz). As previously discussed, first antenna 110 of antenna assembly 100 may be a long term evolution (LTE) antenna operable over one or more long term evolution (LTE) frequency bands, such as a two LTE frequency bands. Accordingly, first antenna 110 may be configured to operate in a first frequency range (e.g., LTE Low Band) depicted in the plot shown in FIG. 7A as well as a second frequency range (e.g., LTE High Band) depicted in plot shown in FIG. 7B.

Referring now specifically to FIG. 7A, an example efficiency of first antenna 110 of the antenna assembly 100 while at least partially enclosed within antenna cabinet 500 is depicted over the LTE Low Band frequency range. As may be seen, curve 710 illustrates the antenna radiation efficiency of first antenna 110 over a range of frequencies spanning from about 600 Megahertz (MHz) to about 1,000 MHz.

Referring now specifically to FIG. 7B, an example efficiency of first antenna 110 of the antenna assembly 100 while at least partially enclosed within antenna cabinet 500 is depicted over the LTE High Band frequency range. As may be seen, curve 720 illustrates the antenna radiation efficiency of first antenna 110 over a range of frequencies spanning from about 1,700 MHz to about 2,220 MHz.

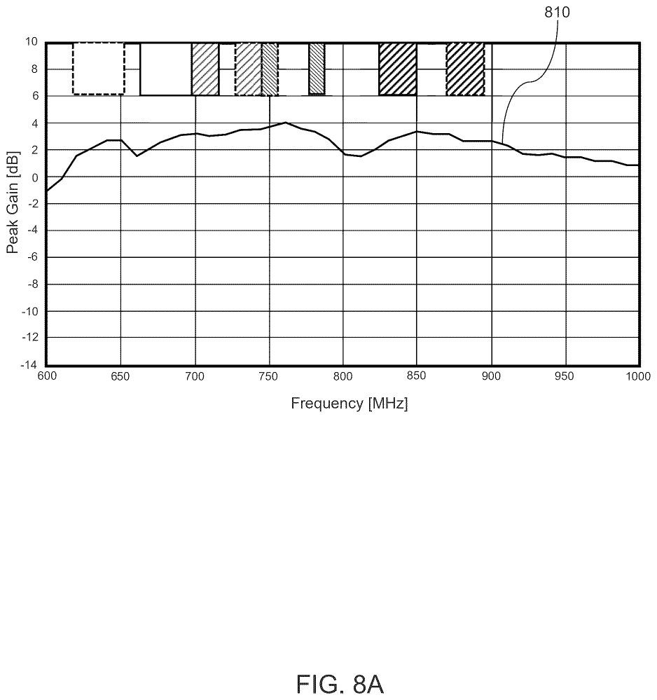

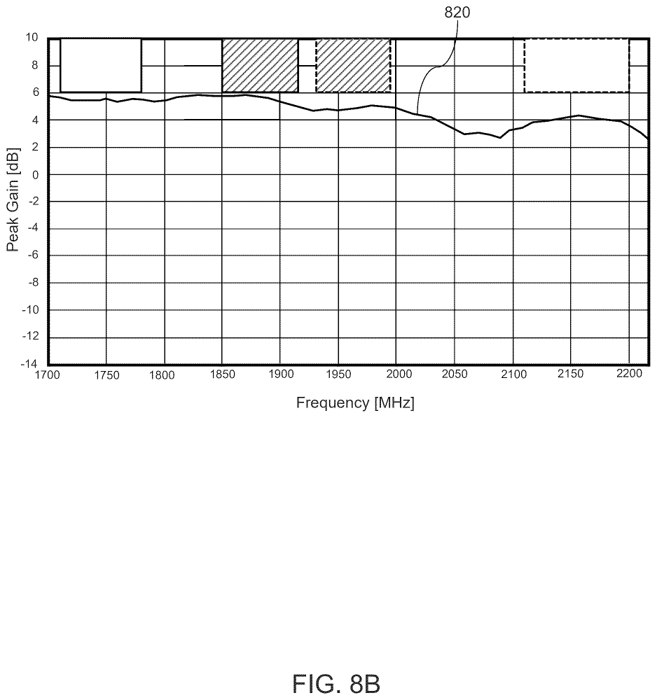

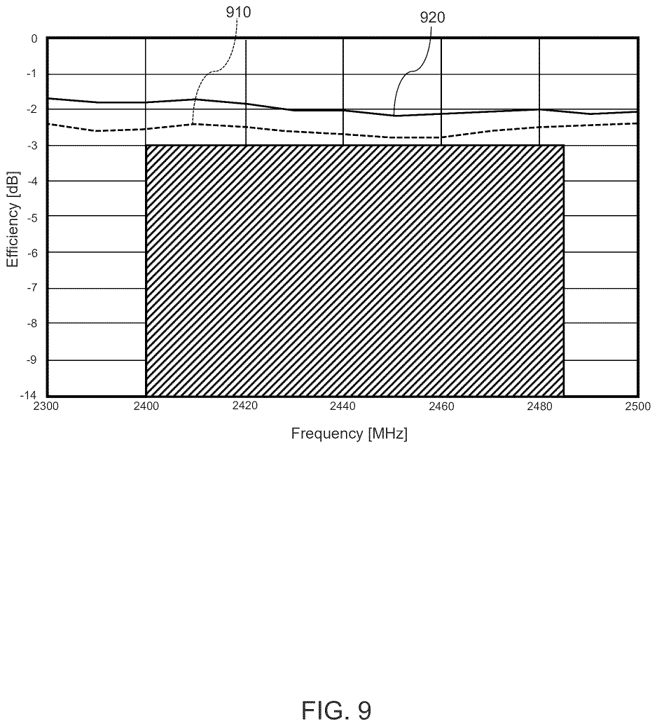

Referring now to FIGS. 8A and 8B, graphical representations of a peak gain of the first antenna 110 of the antenna assembly 100 while at least partially enclosed within antenna cabinet 500 is provided according to example embodiments of the present disclosure. As shown, the plots in FIGS. 8A & 8B illustrate the peak gain (e.g., in decibels [dB]) of the first antenna 110 as a function of frequency (denoted along the horizontal axis in Megahertz). As previously discussed, first antenna 110 of antenna assembly 100 may be a long term evolution (LTE) antenna operable over one or more long term evolution (LTE) frequency bands, such as a two LTE frequency bands. Accordingly, first antenna 110 may be configured to operate in a first frequency range (e.g., LTE Low Band) depicted in the plot shown in FIG. 8A as well as a second frequency range (e.g., LTE High Band) depicted in the plot shown in FIG. 8B.

Referring now specifically to FIG. 8A, an example peak gain of first antenna 110 of the antenna assembly 100 while at least partially enclosed within antenna cabinet 500 is depicted over the LTE Low Band frequency range. As may be seen, curve 810 illustrates the gain pattern or radiation pattern of first antenna 110 over a range of frequencies spanning from about 600 MHz to about 1,000 MHz.

Referring now specifically to FIG. 8B, an example peak gain of first antenna 110 of the antenna assembly 100 while at least partially enclosed within antenna cabinet 500 is depicted over the LTE High Band frequency range. As may be seen, curve 820 illustrates the gain pattern or radiation pattern of first antenna 110 over a range of frequencies spanning from about 1,700 MHz to about 2,220 MHz.

FIG. 9 provides a plot of example efficiencies (e.g., antenna radiation efficiencies) of a second antenna 120 and a third antenna 130 of the antenna assembly 100 while at least partially enclosed within antenna cabinet 500 according to example embodiments of the present disclosure. As shown, the plot in FIG. 9 illustrates the efficiency (e.g., in decibels [dB]) of the second antenna 120 and the third antenna 130 as a function of frequency (denoted along the horizontal axis in Megahertz). As previously discussed, second antenna 120 and/or third antenna 130 of antenna assembly 100 may be operable over one or more frequency bands in a range from about 2 GHz to about 5 GHz. As may be seen, curve 910 illustrates the antenna radiation efficiency of second antenna 120 over a range of frequencies spanning from about 2,380 MHz (e.g., about 2.38 GHz) to about 2,500 MHz (e.g., about 2.5 GHz). Similarly, curve 920 illustrates the antenna radiation efficiency of third antenna 130 over a range of frequencies spanning from about 2,380 MHz (e.g., about 2.38 GHz) to about 2,500 MHz (e.g., about 2.5 GHz). In some embodiments, the second antenna 120 may be a thread antenna, and the third antenna 130 may be Wifi antenna and/or BLE antenna.

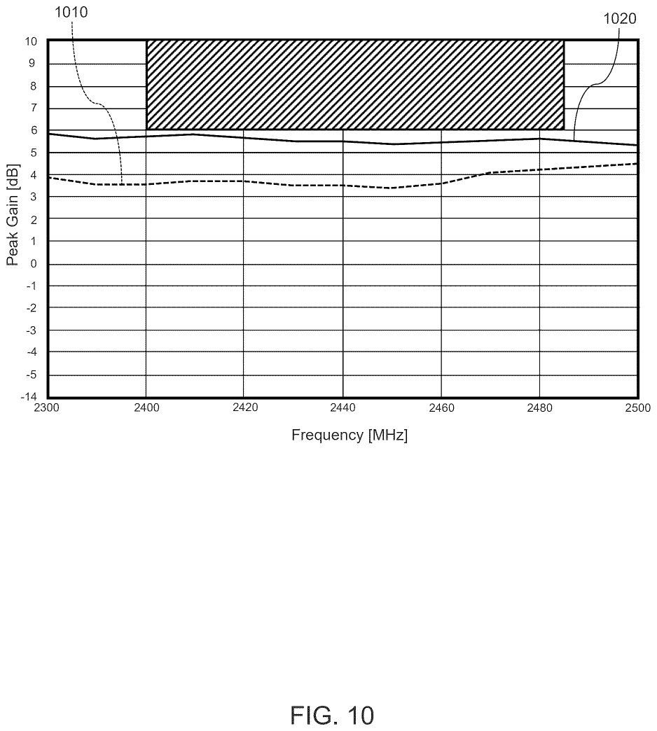

Referring now to FIG. 10, a plot illustrating the peak gains of the second antenna 120 and third antenna 130 of the antenna assembly 100 while at least partially enclosed within antenna cabinet 500 is provided according to example embodiments of the present disclosure. As shown, the plot in FIG. 10 illustrates the peak gain (e.g., in decibels [dB]) of the second antenna 120 and the third antenna 130 as a function of frequency (denoted along the horizontal axis in Megahertz). As previously discussed, second antenna 120 and/or third antenna 130 of antenna assembly 100 may be operable over one or more frequency bands in a range from about 2 GHz to about 5 GHz. As may be seen, curve 1010 illustrates the gain pattern or radiation pattern of second antenna 120 over a range of frequencies spanning from about 2,380 MHz (e.g., about 2.38 GHz) to about 2,500 MHz (e.g., about 2.5 GHz). Similarly, curve 1020 illustrates the gain pattern or radiation pattern of third antenna 130 over a range of frequencies spanning from about 2,380 MHz (e.g., about 2.38 GHz) to about 2,500 MHz (e.g., about 2.5 GHz). In some embodiments, the second antenna 120 may be a thread antenna, and the third antenna 130 may be a Wifi antenna and/or BLE antenna.

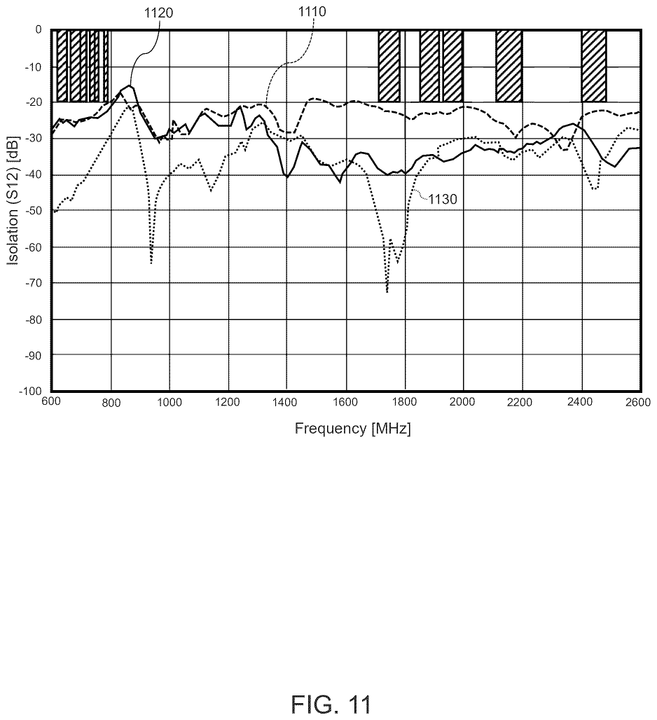

FIG. 11 provides an example antenna isolation plot of example antennas according to example embodiments of the present disclosure. The plot shown in FIG. 11 provides antenna isolation (e.g., S12) as a decibel (dB) value along the vertical axis and the operating frequency in Megahertz (MHz) along the horizontal axis. Specifically, the plot of FIG. 11 shows antenna isolation (e.g., S12) of the first antenna 110, second antenna 120, and third antenna 130 of antenna assembly 100 while at least partially enclosed within antenna cabinet 500 as previously described.

Curve 1110 is associated with the antenna isolation between first antenna 110 and second antenna 120 (e.g., LTE-Thread) of antenna assembly 100. Curve 1120 is associated with the antenna isolation between first antenna 110 and third antenna 130 (e.g., LTE Wifi/BLE) of antenna assembly 100. Curve 1130 is associated with the antenna isolation between second antenna 120 and third antenna 130 (e.g., Wifi/BLE-Thread) of antenna assembly 100.

One example aspect of the present disclosure is directed to an antenna assembly. The antenna assembly includes a carrier having a first surface defining a reference plane, a plurality of apertures extending through the carrier, the plurality of apertures positioned along a first side of the carrier, the first side of the carrier adjacent to a second side and a third side of the carrier. The antenna assembly further includes a plurality of antennas positioned on the first surface. The antenna assembly further includes a plurality of electrical cables extending along the first surface of the carrier, each electrical cable of the plurality of electrical cables coupled to an antenna of the plurality of antennas and extending through an aperture of the plurality of apertures. A first electrical cable of the plurality of electrical cables is in contact with a conductive structure positioned along the first side of the carrier.

In some examples, the plurality of electrical cables are non-intersecting along the first surface.

In some examples, a first aperture of the plurality of apertures is positioned a first distance from the first side of the carrier, and one or more second apertures of the plurality of apertures are positioned one or more second distances from the first side of the carrier, the first distance being different than the second distances.

In some examples, the conductive structure comprises a metal wall of an antenna cabinet that is generally perpendicular to the reference plane.

In some examples, the plurality of antennas include a first antenna coupled to the first electrical cable of the plurality of electrical cables, the first electrical cable extending through a first aperture of the plurality of apertures, a second antenna coupled to a second electrical cable of the plurality of electrical cables, the second electrical cable extending through a second aperture of the plurality of apertures, and a third antenna coupled to a third electrical cable of the plurality of electrical cables, the third electrical cable extending through a third aperture of the plurality of apertures.

In some examples, the first aperture is positioned between the second aperture and the third aperture in a direction parallel to the first side of the carrier.

In some examples, the first antenna is operable over one or more long term evolution (LTE) frequency bands. In some examples, the second antenna and the third antenna are operable over one or more frequency bands in a range from about 2 GHz to about 5 GHz.

In some examples, the plurality of electrical cables comprises a plurality of transmission lines, each transmission line coupled to a FAKRA connector.

Another example aspect of the present disclosure is directed to an antenna assembly. The antenna assembly includes a carrier having a first surface defining a reference plane, a plurality of apertures extending through the carrier, the plurality of apertures positioned along a first side of the carrier, the first side of the carrier adjacent to a second side and a third side of the carrier. The antenna assembly further includes a plurality of electrical cables extending along the first surface of the carrier. The antenna assembly further includes a plurality of antennas positioned on the first surface. The plurality of antennas include a first antenna coupled to a first electrical cable of the plurality of electrical cables, the first electrical cable extending through a first aperture of the plurality of apertures. The plurality of antennas further include a second antenna coupled to a second electrical cable of the plurality of electrical cables, the second electrical cable extending through a second aperture of the plurality of apertures. The plurality of antennas further include a third antenna coupled to a third electrical cable of the plurality of electrical cables, the third electrical cable extending through a third aperture of the plurality of apertures. The first electrical cable is in contact with a conductive structure positioned along the first side of the carrier.

In some examples, the first aperture is positioned between the second aperture and the third aperture in a direction parallel to the first side of the carrier.

In some examples, the plurality of electrical cables are non-intersecting along the first surface.

In some examples, the shape of the first aperture is different than the shape of the second aperture and the shape of the third aperture.

In some examples, the first side of the carrier is greater in length than the second side and the third side of the carrier.

In some examples, the second antenna and the third antenna are positioned closer to the second side of the carrier relative to the first antenna.

In some examples, wherein the first antenna is operable over one or more long term evolution (LTE) frequency bands. In some examples, the second antenna and the third antenna are operable over one or more frequency bands in a range from about 2 GHz to about 5 GHz.

In some examples, the first antenna comprises a long term evolution (LTE) antenna, the second antenna is operable to communicate via an 802.15.4 protocol, and the third antenna is operable to communicate via an 802.11 protocol.

In some examples, the plurality of electrical cables comprises a plurality of transmission lines, each transmission line coupled to a FAKRA connector.

Another example aspect of the present disclosure is directed to an electronic device. The electronic device includes an antenna cabinet comprising a metal sidewall. The electronic device further includes an antenna assembly at least partially enclosed within the antenna cabinet. The antenna assembly includes a carrier having a first surface defining a reference plane, a plurality of apertures extending through the carrier. The antenna assembly further includes a plurality of antennas positioned on the first surface. The antenna assembly further includes a plurality of electrical cables extending along the first surface of the carrier, each electrical cable of the plurality of electrical cables coupled to an antenna of the plurality of antennas and extending through an aperture of the plurality of apertures. A first electrical cable of the plurality of electrical cables is in contact with the metal sidewall of the antenna cabinet.

In some examples, the metal sidewall is generally perpendicular to the reference plane.

In some examples, the plurality of antennas include a first antenna operable over one or more long term evolution (LTE) frequency bands, a second antenna operable over one or more frequency bands in a range from about 2 GHz to about 5 GHz, and a third antenna operable over one or more frequency bands in a range from about 2 GHz to about 5 GHz.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An antenna assembly, comprising:
a carrier having a first surface defining a reference plane, a plurality of apertures extending through the carrier, the plurality of apertures positioned along a first side of the carrier, the first side of the carrier adjacent to a second side and a third side of the carrier;
a plurality of antennas positioned on the first surface; and
a plurality of electrical cables extending along the first surface of the carrier, each electrical cable of the plurality of electrical cables coupled to an antenna of the plurality of antennas and extending through an aperture of the plurality of apertures,
wherein a first electrical cable of the plurality of electrical cables is in contact with a conductive structure positioned along the first side of the carrier.

2. The antenna assembly claim 1, wherein the plurality of electrical cables are non-intersecting along the first surface.

3. The antenna assembly claim 1, wherein a first aperture of the plurality of apertures is positioned a first distance from the first side of the carrier, and one or more second apertures of the plurality of apertures are positioned one or more second distances from the first side of the carrier, the first distance being different than the second distances.

4. The antenna assembly claim 1, wherein the conductive structure comprises a metal wall of an antenna cabinet that is generally perpendicular to the reference plane.

5. The antenna assembly claim 2, wherein the plurality of antennas comprises:
a first antenna coupled to the first electrical cable of the plurality of electrical cables, the first electrical cable extending through a first aperture of the plurality of apertures;
a second antenna coupled to a second electrical cable of the plurality of electrical cables, the second electrical cable extending through a second aperture of the plurality of apertures; and
a third antenna coupled to a third electrical cable of the plurality of electrical cables, the third electrical cable extending through a third aperture of the plurality of apertures.

6. The antenna assembly claim 5, wherein the first aperture is positioned between the second aperture and the third aperture in a direction parallel to the first side of the carrier.

7. The antenna assembly of claim 6, wherein the first antenna is operable over one or more long term evolution (LTE) frequency bands; and
the second antenna and the third antenna are operable over one or more frequency bands in a range from about 2 GHz to about 5 GHz.

8. The antenna assembly of claim 1, wherein the plurality of electrical cables comprises a plurality of transmission lines, each transmission line coupled to a FAKRA connector.

9. An antenna assembly, comprising:
a carrier having a first surface defining a reference plane, a plurality of apertures extending through the carrier, the plurality of apertures positioned along a first side of the carrier, the first side of the carrier adjacent to a second side and a third side of the carrier;
a plurality of electrical cables extending along the first surface of the carrier;
a plurality of antennas positioned on the first surface, the plurality of antennas comprising:
a first antenna coupled to a first electrical cable of the plurality of electrical cables, the first electrical cable extending through a first aperture of the plurality of apertures;
a second antenna coupled to a second electrical cable of the plurality of electrical cables, the second electrical cable extending through a second aperture of the plurality of apertures; and
a third antenna coupled to a third electrical cable of the plurality of electrical cables, the third electrical cable extending through a third aperture of the plurality of apertures,
wherein the first electrical cable is in contact with a conductive structure positioned along the first side of the carrier.

10. The antenna assembly claim 9, wherein the first aperture is positioned between the second aperture and the third aperture in a direction parallel to the first side of the carrier.

11. The antenna assembly claim 9, wherein the plurality of electrical cables are non-intersecting along the first surface.

12. The antenna assembly claim 10, wherein the shape of the first aperture is different than the shape of the second aperture and the shape of the third aperture.

13. The antenna assembly claim 9, wherein the first side of the carrier is greater in length than the second side and the third side of the carrier.

14. The antenna assembly claim 10, wherein the second antenna and the third antenna are positioned closer to the second side of the carrier relative to the first antenna.

15. The antenna assembly claim 14, wherein the first antenna is operable over one or more long term evolution (LTE) frequency bands, and
the second antenna and the third antenna are operable over one or more frequency bands in a range from about 2 GHz to about 5 GHz.

16. The antenna assembly of claim 9, wherein the first antenna comprises a long term evolution (LTE) antenna;
the second antenna is operable to communicate via an 802.15.4 protocol; and
the third antenna is operable to communicate via an 802.11 protocol.

17. The antenna assembly of claim 9, wherein the plurality of electrical cables comprises a plurality of transmission lines, each transmission line coupled to a FAKRA connector.

18. An electronic device, comprising:
an antenna cabinet comprising a metal sidewall; and
an antenna assembly at least partially enclosed within the antenna cabinet, the antenna assembly comprising:
a carrier having a first surface defining a reference plane, a plurality of apertures extending through the carrier;
a plurality of antennas positioned on the first surface; and
a plurality of electrical cables extending along the first surface of the carrier, each electrical cable of the plurality of electrical cables coupled to an antenna of the plurality of antennas and extending through an aperture of the plurality of apertures,
wherein a first electrical cable of the plurality of electrical cables is in contact with the metal sidewall of the antenna cabinet.

19. The electronic device of claim 18, wherein the metal sidewall is generally perpendicular to the reference plane.

20. The electronic device of claim 18, wherein the plurality of antennas comprises:
a first antenna operable over one or more long term evolution (LTE) frequency bands;
a second antenna operable over one or more frequency bands in a range from about 2 GHz to about 5 GHz; and
a third antenna operable over one or more frequency bands in a range from about 2 GHz to about 5 GHz.
